(19) United States
(12) Patent Application Publication
(10) Pub. No.: US 2002/0180703 A1
(43) Pub. Date: Dec. 5, 2002

(54) Constant even contact mouse device

(76) Inventor: Brett J. Muir, Pacifica, CA (US)

Correspondence Address: ERIC B. MEYERTONS, CONLEY, ROSE & TAYON, P.C., P.O. BOX 398, AUSTIN, TX, 78767-0398, US

(21) Appl. No.: 09/874,723

(22) Filed: Jun. 4, 2001

(51) Int. Cl. G09G 5/08

(52) U.S. Cl. 345/163

(57) ABSTRACT

A computer mouse including a body, a mouse ball, one or more motion sensors, and a supporting member is disclosed. The mouse ball may be urged toward the mouse by the supporting member. The supporting member may include one or more springs, one or more torsion bar, or one or more magnets.

### BACKGROUND OF THE INVENTION

1. Field of the Invention

Embodiments disclosed herein generally relate to computer input devices.

2. Description of Related Art

Computer use has become an important productivity improvement tool in the United States and throughout the world. In general, it would be difficult to imagine the operation of a business without the predominant use of computers. Internet-based commerce, often referred to as e-commerce, has provided further impetus to the widespread use of a computer in home and in the business.

It is not uncommon for a person to work with a computer for a majority of a workday. Professionals such as Graphic designers, secretaries, software engineers, attorneys, and the like may provide inputs to a computer by actuating a stationary mouse (commonly called a trackball), or by actuating a movable mouse by sliding it about a planar surface. Continuous operation of such a mouse over a substantial period of time may result in fatigue and discomfort. Additionally, continuous use of a mouse may cause wear of mouse components. Such wear may change dimension of mouse components. Also, thermal expansion or contraction of mouse components may change dimensions of mouse components. If dimensions of certain components change, the mouse may exhibit unintended behavior. For example, behavior such as “cursor jitter” or uneven rolling of mouse components may be attributed to dimensional changes in a roller of the mouse. In addition, wear and/or thermal effects may also cause other changes in the mouse which may adversely affect performance. For example, wear and/or thermal changes may cause changes in friction coefficients. Such changes may lead to degraded performance of the mouse.

Contact between a mouse ball and motion sensors disposed within the body of the mouse may be maintained primarily by force of gravity and forces exerted by a user of the mouse. In some instances, these forces may not be sufficient to maintain constant, even contact between the mouse ball and the motion sensors. It is believed that discontinuous and/or uneven contact between a mouse ball and one or more motion sensors may cause the degraded mouse performance previously described.

The following U.S. Patents generally describe mouse type input devices: U.S. Pat. No. 6,011,543 to Tian, U.S. Pat. No. 4,612,539 to Hosogoe et al., U.S. Pat. No. 5,767,841 to Hartman, U.S. Pat. No. 5,008,528 to Duchon, and U.S. Pat. No. 5,696,537 to Solhjell; all of which are incorporated herein by reference.

### SUMMARY OF THE INVENTION

Embodiments disclosed herein relate to computer mice configured to at least partially compensate for the effects of component wear and/or thermal changes in components. In an embodiment, the mouse ball may be coupled to the motion sensors by the use of a supporting member. The supporting member may be configured to force the mouse ball toward the motion sensors. In some embodiments, a mouse ball may be coupled to a mouse by use of one or more springs. In some embodiments, a mouse ball may be coupled to a mouse by use of magnetic forces. In some embodiments, a mouse ball may be coupled to a mouse by use of one or more torsion bars.

An advantage of embodiments disclosed herein may be that mouse performance degradation over time may be minimized. An additional advantage of embodiments disclosed herein may be that operation of such embodiments may require less force exerted by a user.

### BRIEF DESCRIPTION OF THE DRAWINGS

Further advantages of the present invention will become apparent to those skilled in the art with the benefit of the following detailed description of embodiments and upon reference to the accompanying drawings wherein:

FIG. 1 is a schematic view of an embodiment of a computer system;

FIGS. 2a and 2b are schematic side cutaway views of an embodiment of a computer mouse; and

FIGS. 3a, 3b, 3c, and 3d are schematic side cutaway views of an embodiment of a computer mouse.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents and alternatives falling within the spirit and scope of the present invention as defined by the appended claims.

### DETAILED DESCRIPTION OF THE PREFERRED EMBODIMENTS

The term “computer system” as used herein generally describes the hardware and software components that in combination allow the execution of computer programs. The computer programs may be implemented in software, hardware, or a combination of software and hardware. A computer system's hardware generally includes a processor, memory media, and input/output (I/O) devices. As used herein, the term “processor” generally describes the logic circuitry that responds to and processes the basic instructions that operate a computer system. The term “memory medium” includes an installation medium, e.g., a CD-ROM, floppy disks; a volatile computer system memory such as DRAM, SRAM, EDO RAM, Rambus RAM, etc.; or a non-volatile memory such as optical storage or a magnetic medium, e.g., a hard drive. The term “memory” is used synonymously with “memory medium” herein. The memory medium may comprise other types of memory or combinations thereof. In addition, the memory medium may be located in a first computer in which the programs are executed, or may be located in a second computer that connects to the first computer over a network. In the latter instance, the second computer provides the program instructions to the first computer for execution. In addition, the computer system may take various forms, including a personal computer system, mainframe computer system, workstation, network appliance, Internet appliance, personal digital assistant (PDA), television system or other device. In general, the term “computer system” can be broadly defined to encompass any device having a processor that executes instructions from a memory medium.

The memory medium preferably stores a software program or programs for the reception, storage, analysis, and transmittal of information produced by an Analyte Detection Device (ADD). The software program(s) may be implemented in any of various ways, including procedure-based techniques, component-based techniques, and/or object-oriented techniques, among others. For example, the software program may be implemented using ActiveX controls, C++ objects, JavaBeans, Microsoft Foundation Classes (MFC), or other technologies or methodologies, as desired.

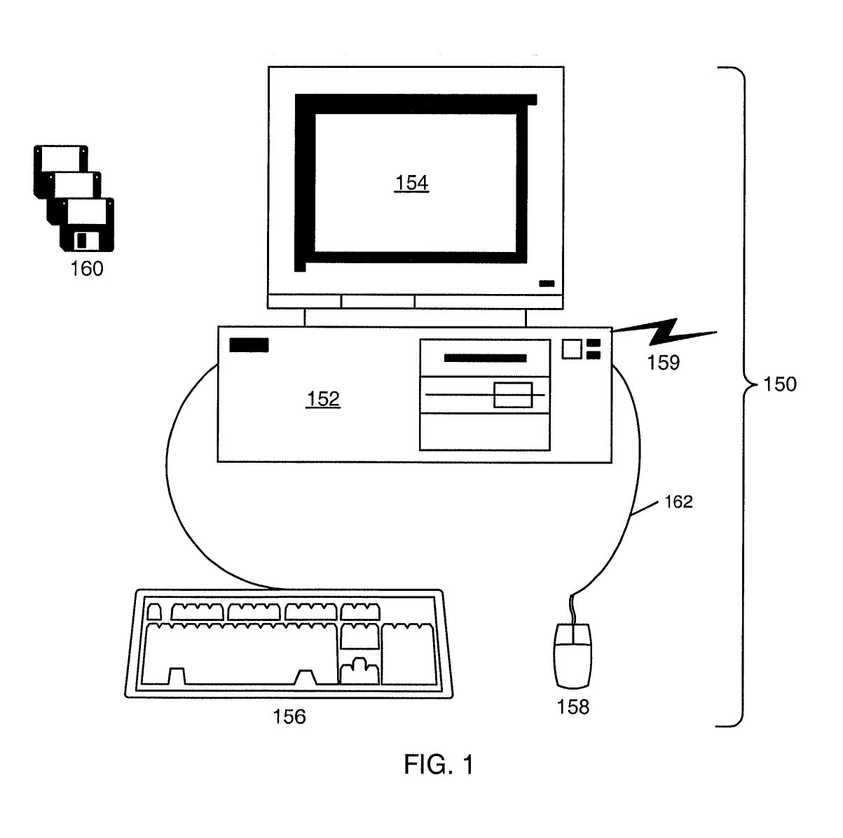

FIG. 1 depicts an embodiment of a computer system 150. Computer system 150 may include components such as a CPU 152 with an associated memory medium such as floppy disks 160, CD-ROMs, or hard disk (not shown). Computer system 150 may further include a display device such as monitor 154. Additionally computer system 150 may include one or more input devices such as a keyboard 156, mouse 158, or joystick (not shown).

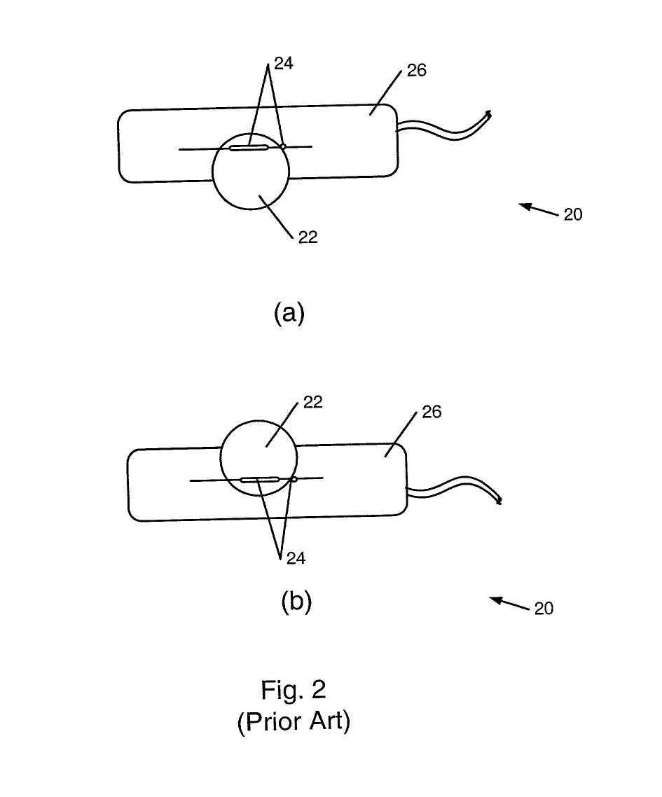

In an embodiment as depicted in FIG. 2, a mouse 20 may include a body, 26, a mouse ball 22, and one or more motion sensors 24. A mouse may be configured so that mouse ball 22 may be rolled across a surface, as in FIG. 2a. A mouse may also be configured so that mouse ball 22 may be rolled by a user's fingers, as in FIG. 2b. In either configuration, mouse ball 22 may be moveably coupled to motion sensors 24. A user may move mouse 20 and/or mouse ball 22 to provide an input to a computer. Movement of mouse ball 22 may be frictionally transferred to motion sensors 24. Motion sensors 24 may then send a signal corresponding to the movement of mouse ball 22.

Under certain circumstances, movement of mouse ball 22 may not cause motion sensors 24 to send a signal corresponding to the movement of mouse ball 22. For example, if mouse ball 22 and/or motion sensors 24 have experienced substantial wear, mouse ball 22 may not contact motion sensors 24 evenly and continuously. In another example, thermal expansion or contraction of mouse ball 22, and/or motion sensors 24 may result in uneven, or discontinuous contact between mouse ball 22 and motion sensors 24. Uneven or discontinuous contact between mouse ball 22 and motion sensors 24 may result in uneven or discontinuous transfer of movement from mouse ball 22 to motion sensors 24. In another example, dust, and/or other contaminants may be present on the surface of mouse ball 22 or motion sensors 24. In such a case, frictional transfer of motion from mouse ball 22 to motion sensors 24 may be inhibited. In cases as described above, the signal sent by motion sensors 24 may be uneven or “jittery.”

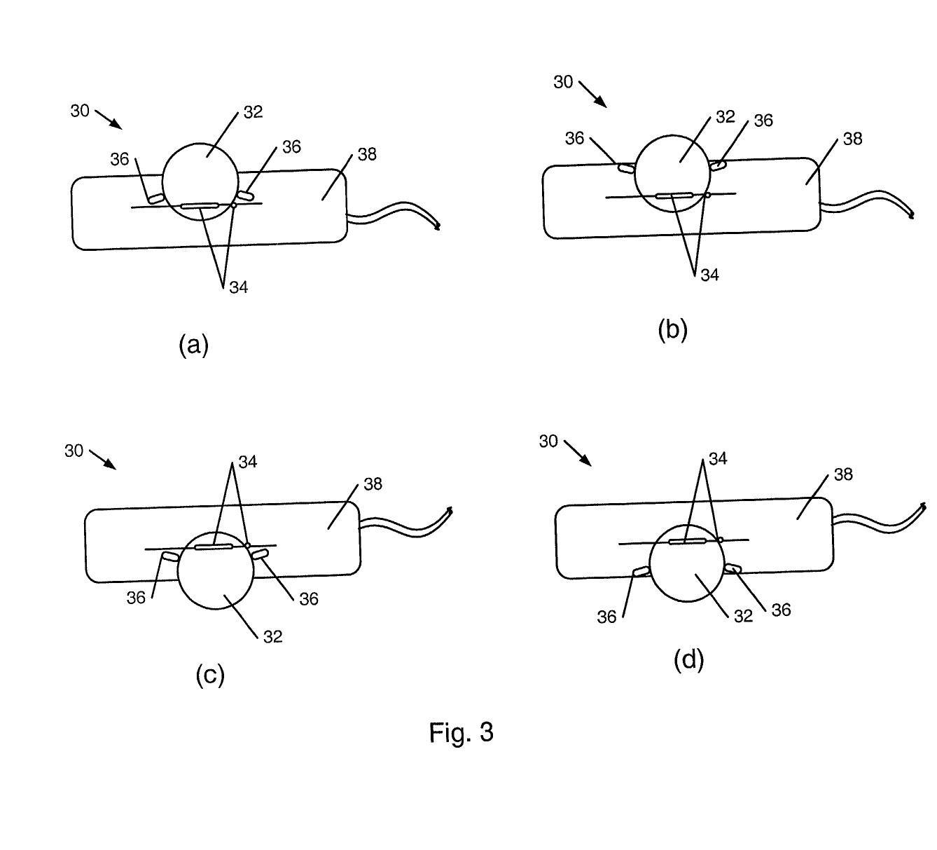

In an embodiment as depicted in FIG. 3a, 3b, 3c, and 3d mouse 30 may include supporting member 36 coupled to body 38. Supporting member 36 may be configured to provide a force urging mouse ball 32 into contact with motion sensors 34. The force created by supporting member 36 may push or pull mouse ball 32 in the direction of motion sensors 34. In an embodiment, supporting member 36 may include a spring mounted roller or other spring arrangement. The spring may provide a force which tends to push mouse ball 32 toward motion sensors 34. In an embodiment, supporting member 36 may include a magnet or electromagnet which may attract a metallic portion of mouse ball 32. In an embodiment, supporting member 36 may include a torsion bar. The torsion bar spring may provide a force which tends to push mouse ball 32 toward motion sensors 34.

It is believed that supporting member 36 may provide improved contact between mouse ball 32 and motion sensors 34. Improved contact means contact which is more even and continuous. Improved contact between mouse ball 32 and motion sensors 34 may reduce the adverse effects of wear and/or thermal dimensional changes on the performance of mouse 30. Improved contact between mouse ball 32 and motion sensors 34 may reduce the adverse effects of dust and/or other contaminants on the performance of mouse 30.

In some embodiments, mouse ball 32 may be a lightweight mouse ball. It is believed that the urging force provided by supporting member 36, may allow a lightweight mouse ball to be used effectively. In such embodiments, the amount of force, which a user may need to apply to mouse 30 in order to operate mouse 30, may be reduced.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A computer mouse comprising:
a body;
a mouse ball disposed within the body;
a motion sensor disposed within the body, wherein the motion sensors are configured to monitor motion of the mouse ball during use; and
a supporting member coupled to the body and the mouse ball, wherein the supporting member is configured to force the mouse ball toward the motion sensors.

2. The computer mouse of claim 1, wherein the supporting member comprises a torsion bar.

3. The computer mouse of claim 1, wherein at least a portion of the mouse ball comprises a magnetic metal, and wherein the supporting member comprises a magnet coupled to the body, wherein the magnet is configured to apply a magnetic force to the mouse ball such that the mouse ball remains proximate to the motion detectors.

4. The computer mouse of claim 1, wherein the supporting member comprises a spring.

5. The computer mouse of claim 1, wherein the mouse ball is movable by movement of the mouse by the user while the mouse ball is in contact with a surface.

6. The computer mouse of claim 1, wherein the mouse ball is movable by contact of the mouse ball with a body part of a users during use.

7. The computer mouse of claim 1, wherein the mouse ball is movable by movement of the mouse by the user while the mouse ball is in contact with a surface, and wherein the mouse ball is movable by contact of the mouse ball with a body part of a users during use.

8. The computer mouse of claim 1, wherein the mouse is couplable to a personal computer.

9. A method of inputting data into a computer using a computer mouse comprising:
providing a computer mouse, the computer mouse comprising:
a body;
a mouse ball disposed within the body;
a motion sensor disposed within the body, wherein the motion sensors are configured to monitor motion of the mouse ball during use; and
a supporting member coupled to the body and the mouse ball, wherein the supporting member is configured to force the mouse ball toward the motion sensors; and
moving the mouse ball, wherein movement of the mouse ball is detected by the motion sensors, and wherein the motion sensors create a signal signifying the inputted data.

10. The computer mouse of claim 9, wherein the supporting member comprises a torsion bar.

11. The computer mouse of claim 9, wherein at least a portion of the mouse ball comprises a magnetic metal, and wherein the supporting member comprises a magnet coupled to the body, wherein the magnet is configured to apply a magnetic force to the mouse ball such that the mouse ball remains proximate to the motion detectors.

12. The computer mouse of claim 9, wherein the supporting member comprises a spring.

13. The computer mouse of claim 9, wherein moving the mouse ball comprises moving the computer mouse while the mouse ball is in contact with a surface.

14. The computer mouse of claim 9, wherein moving the mouse ball comprises moving the computer mouse with a body part of a user.

15. The computer mouse of claim 9, wherein moving the mouse ball comprises moving the computer mouse while the mouse ball is in contact with a surface, and wherein moving the mouse ball comprises moving the computer mouse with a body part of a user.

16. The computer mouse of claim 9, wherein the mouse is couplable to a personal computer.
